(19) United States
(12) Patent Application Publication
(10) Pub. No.: US 2026/0214028 A1
(43) Pub. Date: Jul. 23, 2026

(54) Method for Adjusting Quality of Service (QoS) Policy of Service, and Terminal and Communication Device

(71) Applicant: VIVO MOBILE COMMUNICATION CO., LTD., Dongguan (CN)

(72) Inventor: Kai Zhu, Dongguan (CN)

(21) Appl. No.: 19/569,178

(22) Filed: Mar. 17, 2026

Related U.S. Application Data
(63) Continuation of application No. PCT/CN2024/119440, filed on Sep. 18, 2024.

(30) Foreign Application Priority Data
Sep. 21, 2023 (CN) 202311231219.8

(51) Int. Cl. H04L 41/5003; H04L 41/0894

(52) U.S. Cl. CPC H04L 41/5003; H04L 41/0894

(57) ABSTRACT

A method for adjusting a QoS policy of a service includes: a first communication device receives device status information of a terminal, where the device status information is used to characterize a device state of the terminal during execution of a first service; the first communication device determines a QoS policy of the first service based on the device status information and a first rule, where the QoS policy is used to adjust a transmission parameter of service data of the first service; and the first communication device adjusts a QoS parameter of the first service based on the QoS policy, where the QoS parameter includes transmission delays of uplink service data and downlink service data of the first service; where the first rule is that a sum of the transmission delays of the uplink service data and the downlink service data satisfies a preset condition.

### CROSS-REFERENCE TO RELATED APPLICATIONS

This application is a Bypass Continuation Application of International Patent Application No. PCT/CN2024/119440 filed Sep. 18, 2024, and claims priority to Chinese Patent Application No. 202311231219.8 filed Sep. 21, 2023, the disclosures of which are hereby incorporated by reference in their entireties.

### BACKGROUND OF THE INVENTION

### Field of the Invention

This application pertains to the field of communication technologies, and in particular, relates to a method for adjusting a quality of service QoS policy of a service, a terminal, a communication device, and a non-transitory readable storage medium.

### Description of Related Art

With the development of electronic technologies, high-quality extended reality (XR) applications are becoming increasingly accessible and developing at a rapid pace. Therefore, there is a growing demand to enhance related functions of the 5th-generation mobile communication technology system (5GS) to provide better support for XR application services.

### SUMMARY OF THE INVENTION

According to a first aspect, a method for adjusting a QoS policy of a service is provided, and is executed by a first communication device. The method includes: A first communication device receives device status information of a terminal, where the device status information is used to characterize a device state of the terminal during execution of a first service; the first communication device determines a QoS policy of the first service based on the device status information and a first rule, where the QoS policy of the first service includes an uplink QoS policy of the first service and a downlink QoS policy of the first service, and the QoS policy is used to adjust a transmission parameter of service data of the first service; and the first communication device adjusts a QoS parameter of the first service based on the QoS policy, where the QoS parameter includes transmission delays of uplink service data and downlink service data of the first service; where the first rule is that a sum of the transmission delays of the uplink service data and the downlink service data satisfies a preset condition.

According to a second aspect, a method for adjusting a QoS policy of a service is provided, and is executed by a terminal. The method includes: A terminal sends device status information to a first communication device, where the device status information is used to characterize a device state of the terminal during execution of a first service; where the device status information is used to determine a QoS policy of the first service; the QoS policy is used to adjust a transmission parameter of service data of the first service; the QoS policy of the first service includes an uplink QoS policy of the first service and a downlink QoS policy of the first service; the QoS policy is used to adjust a QoS parameter of the first service; and the QoS parameter includes transmission delays of uplink service data and downlink service data of the first service.

According to a third aspect, an apparatus for adjusting a QoS policy of a service is provided. The apparatus includes: a receiving module, a determining module, and an adjustment module. The receiving module is configured to receive device status information of a terminal, where the device status information is used to characterize a device state of the terminal during execution of a first service; the determining module is configured to determine a QoS policy of the first service based on the device status information received by the receiving module and a first rule, where the QoS policy of the first service includes an uplink QoS policy of the first service and a downlink QoS policy of the first service, and the QoS policy is used to adjust a transmission parameter of service data of the first service; and the adjustment module is configured to adjust a QoS parameter of the first service based on the QoS policy determined by the determining module, where the QoS parameter includes transmission delays of uplink service data and downlink service data of the first service; where the first rule is that a sum of the transmission delays of the uplink service data and the downlink service data satisfies a preset condition.

According to a fourth aspect, an apparatus for adjusting a QoS policy of a service is provided. The apparatus includes a sending module, where the sending module is configured to send device status information to a first communication device, where the device status information is used to characterize a device state of a terminal during execution of a first service; where the device status information is used to determine a QoS policy of the first service; the QoS policy is used to adjust a transmission parameter of service data of the first service; the QoS policy of the first service includes an uplink QoS policy of the first service and a downlink QoS policy of the first service; the QoS policy is used to adjust a QoS parameter of the first service; and the QoS parameter includes transmission delays of uplink service data and downlink service data of the first service.

According to a fifth aspect, a communication device is provided. The communication device includes a processor and a memory, where the memory stores a program or an instruction executable on the processor; and when the program or instruction is executed by the processor, the steps of the method according to the first aspect are implemented.

According to a sixth aspect, a communication device is provided, including a processor and a communication interface. The processor is configured to determine a QoS policy of a first service based on device status information and a first rule, where the QoS policy of the first service includes an uplink QoS policy of the first service and a downlink QoS policy of the first service, and the QoS policy is used to adjust a transmission parameter of service data of the first service; a QoS parameter of the first service is adjusted based on the QoS policy, where the QoS parameter includes transmission delays of uplink service data and downlink service data of the first service; where the first rule is that a sum of the transmission delays of the uplink service data and the downlink service data satisfies a preset condition. The communication interface is configured to receive device status information of a terminal, where the device status information is used to characterize a device state of the terminal during execution of the first service.

According to a seventh aspect, a terminal is provided. The terminal includes a processor and a memory, where the memory stores a program or an instruction executable on the processor, and when the program or instruction is executed by the processor, the steps of the method according to the second aspect are implemented.

According to an eighth aspect, a terminal is provided, including a processor and a communication interface. The communication interface is configured to send device status information to a first communication device, where the device status information is used to characterize a device state of a terminal during execution of a first service; the device status information is used to determine a QoS policy of the first service; the QoS policy is used to adjust a transmission parameter of service data of the first service; the QoS policy of the first service includes an uplink QoS policy of the first service and a downlink QoS policy of the first service; the QoS policy is used to adjust a QoS parameter of the first service; and the QoS parameter includes transmission delays of uplink service data and downlink service data of the first service.

According to a ninth aspect, a non-transitory readable storage medium is provided. The non-transitory readable storage medium stores a program or an instruction, and when the program or the instruction is executed by a processor, the steps of the method according to the first aspect are implemented, or the steps of the method according to the second aspect are implemented.

According to a tenth aspect, a wireless communication system is provided, including: a terminal and a communication device. The communication device may be configured to execute the steps of the method according to the first aspect. The terminal may be configured to execute the steps of the method according to the second aspect.

According to an eleventh aspect, a chip is provided. The chip includes a processor and a communication interface. The communication interface is coupled to the processor. The processor is configured to run a program or an instruction to implement the method according to the first aspect, or implement the method according to the second aspect.

According to a twelfth aspect, a computer program/program product is provided. The computer program/program product is stored in a non-transitory storage medium. The program/program product is executed by at least one processor to implement the steps of the method for adjusting a QoS policy of a service according to the first aspect.

### BRIEF DESCRIPTION OF THE DRAWINGS

FIG. 1 is a schematic diagram of a possible structure of a communication system in an embodiment of this application;

FIG. 2 is a first schematic flowchart of a method for adjusting a QoS policy of a service provided in an embodiment of this application;

FIG. 3 is a second schematic flowchart of a method for adjusting a QoS policy of a service provided in an embodiment of this application;

FIG. 4 is a third schematic flowchart of a method for adjusting a QoS policy of a service provided in an embodiment of this application;

FIG. 5 is a fourth schematic flowchart of a method for adjusting a QoS policy of a service provided in an embodiment of this application;

FIG. 6 is a fifth schematic flowchart of a method for adjusting a QoS policy of a service provided in an embodiment of this application;

FIG. 7 is a sixth schematic flowchart of a method for adjusting a QoS policy of a service provided in an embodiment of this application;

FIG. 8 is a seventh schematic flowchart of a method for adjusting a QoS policy of a service provided in an embodiment of this application;

FIG. 9 is a schematic diagram of a structure of an apparatus for adjusting a QoS policy of a service provided in an embodiment of this application;

FIG. 10 is a schematic diagram of another structure of an apparatus for adjusting a QoS policy of a service provided in an embodiment of this application;

FIG. 11 is a schematic diagram of a hardware structure of a communication device provided in an embodiment of this application;

FIG. 12 is a schematic diagram of a hardware structure of a terminal provided in an embodiment of this application; and

FIG. 13 is a schematic diagram of a hardware structure of a network-side device provided in an embodiment of this application.

### DESCRIPTION OF THE INVENTION

The technical solutions in the embodiments of this application are clearly described below with reference to the accompanying drawings in the embodiments of this application. It is clear that the described embodiments are some but not all embodiments of this application. All other embodiments obtained by those of ordinary skill in the art based on the embodiments in this application fall within the protection scope of this application.

The terms “first”, “second” and the like in this application are used to distinguish similar objects and are not necessarily used to describe a specific order or sequence. It should be understood that the terms used in this way can be interchanged under appropriate circumstances, so that the embodiments of this application can be implemented in sequences other than those illustrated or described herein, and terms “first” and “second” distinguish objects that are usually of a same type, and do not limit a quantity of objects, for example, one or more first objects may be provided. In addition, “or” in this application indicates at least one of the connected objects. For example, “A or B” includes three scenarios, such as scenario one: including A but not including B; scenario two: including B but not including A; scenario three: including both A and B. The character “/” generally indicates that the preceding and following related objects are in an “or” relationship.

The term “indication” in this application can be either a direct indication (or explicit indication) or an indirect indication (or implicit indication). The direct indication may mean that a sender explicitly informs a receiver of information, an operation to be executed, or a request result in a sent indication. The indirect indication may mean that a receiver determines corresponding information based on an indication sent by a sender, or makes a judgment and determines an operation to be executed or a request result based on a judgment result.

It should be noted that the technologies described in the embodiments of this application are not limited to long term evolution (LTE)/LTE-Advanced (LTE-A) system, and may alternatively be applied to other wireless communication systems, such as code division multiple access (CDMA) system, time division multiple access (TDMA) system, frequency division multiple access (FDMA) system, orthogonal frequency division multiple access (OFDMA) system, single-carrier frequency-division multiple access (SC-FDMA) system, or other systems. The terms “system” and “network” in the embodiments of this application are often used interchangeably, and the described technologies can be used not only in the above systems and radio technologies, but also in other systems and radio technologies. In the following descriptions, the new radio (NR) system is described for exemplary purposes, and NR terminology is used in most of the following descriptions, but these technologies can also be applied to systems other than the NR system, such as the 6th Generation (6G) communication system.
(1) Virtual reality (VR) is a computer-generated simulation system capable of creating and allowing users to experience virtual worlds. Computers generate simulated environments, immersing users in the environment isolating from reality.
(2) Augmented reality (AR) is a technology that calculates positions and angles of camera images in real time and overlays corresponding images, videos, 3D (three dimensions) models, allowing users to visually perceive virtual objects in the real environment, achieving “augmentation” of real scenes.
(3) Extended reality (XR) is a technology that combines real environment and virtual environment with computers to create a virtual environment for human-machine interaction. XR is a general term for multiple technologies such as AR and VR. By using computer technologies, XR can create for users an environment combining real environment and virtual environment and allowing for human-machine interaction through wearable devices.

With the development of electronic technologies, high-quality extended reality (XR) applications are becoming increasingly accessible and developing at a rapid pace. Therefore, there is a growing demand to enhance related functions of the 5th-generation mobile communication technology system (5GS) to provide better support for XR application services.

Currently, integration of XR applications with cloud gaming (CG) services relies heavily on interactions between humans and devices. This means that a user provides instructions, for example, waving a gamepad or making a certain gesture, an XR device generates and feed backs new images based on the user's instructions, and a display device of the XR device displays the images. In this process, delays are inevitable. Due to the interactive nature, it is reasonable for a network-side device to ensure a round-trip delay from an XR device to a terminal, rather than just ensuring a one-way (uplink or downlink) delay.

The XR device typically reduces end-to-end delays by adjusting uplink and downlink quality of service (QoS) parameters. However, under the related QoS framework of 5GS, uplink and downlink QoS parameters are configured independently, for example, uplink QoS configuration is only based on an uplink delay, and downlink QoS configuration is only based on a downlink delay. The XR device reduces end-to-end delays by independently adjusting uplink QoS parameters or independently adjusting downlink QoS parameters. In this way, although a network-side device can monitor the QoS parameters of the XR device and make adjustments, the real-time performance is relatively low, which may damage the overall quality of experience (QoE).

In summary, how to reduce the round-trip delay from the XR device to the network-side device is an urgent technical problem to be solved in the field.

For most XR applications integrated with the CG service, the complete round-trip delay Tₑ₂ₑ from an XR device to a terminal may be expressed by the following formula:
Tₑ₂ₑ =MTP−T_{processing}−T_{render}≤20 ms−T_{processing}−T_{render}

In the formula, MTP (motion-to-photon) represents a delay from motion to image, and a value of this delay is determined by the physiological characteristics of the human brain, generally with an upper limit of 20 ms. If this delay is exceeded, a user no longer has an immersive experience. Therefore, a delay of 20 ms is usually a hard constraint for XR applications integrated with CG services.

T_{processing} represents a time required for processing user's input instructions on the cloud or network-side device and calculating image data corresponding to the input instructions.

T_{render} represents a delay incurred when a user's XR head-mounted display (HMD) renders image data received on a network and displays the data on a device screen.

Since XR devices usually have various forms and dimensions, such as glasses-type or head-mounted displays, and different devices have different capabilities, such as processing capability, battery capacity, and heat dissipation capability, network-side devices not only need to adjust QoS configurations based on wireless capabilities of the devices, but also adjust QoS configurations based on real-time hardware processing status of the devices. For example, when a temperature of the XR device is excessively high, GPU performance is reduced due to a thermal control policy, so T_{render} increases accordingly. It would be helpful if the network-side device can perceive such information and adjust an uplink or downlink QoS policy accordingly to compensate for the extended T_{render}.

Therefore, in the embodiments of this application, a first communication device receives device status information of a terminal, where the device status information is used to characterize a device state of the terminal during execution of a first service; the first communication device determines a QoS policy of the first service based on the device status information and a first rule, where the QoS policy of the first service includes an uplink QoS policy of the first service and a downlink QoS policy of the first service, and the QoS policy is used to adjust a transmission parameter of service data of the first service; and the first communication device adjusts a QoS parameter of the first service based on the QoS policy, where the QoS parameter includes transmission delays of uplink service data and downlink service data of the first service; where the first rule is that a sum of the transmission delays of the uplink service data and the downlink service data satisfies a preset condition. In this way, the first communication device may determine the QoS policy of the first service based on the device status information of the terminal, thereby enabling the first communication device to adjust both the transmission delays of the uplink service data and the downlink service data of the first service, to reduce a round-trip delay between the terminal and the first communication device, and thus ensure immersive user experience.

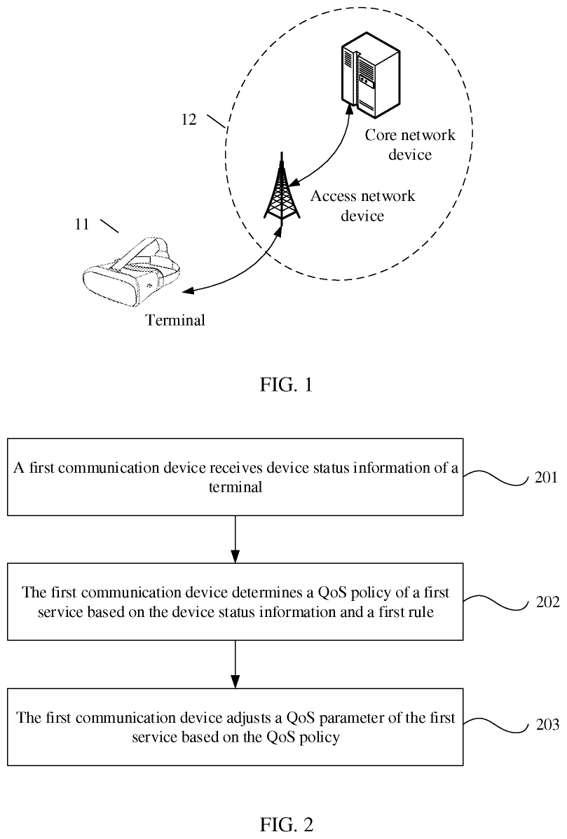

FIG. 1 is a block diagram of a wireless communication system applicable to the embodiments of this application. The wireless communication system includes a terminal 11 and a network-side device 12. The terminal 11 may be a mobile phone, a tablet personal computer, a laptop computer, a notebook computer, a personal digital assistant (PDA), a palmtop computer, a netbook, an ultra-mobile personal computer (UMPC), a mobile internet device (MID), augmented reality (AR)/virtual reality (VR) device, robot, wearable device, flight vehicle, vehicle user equipment (VUE), shipborne device, pedestrian user equipment (PUE), smart home (home devices with wireless communication functions, such as refrigerators, televisions, washing machines, or furniture), game console, personal computer (PC), automated teller machine, self-service machine, and other terminal-side devices. Wearable devices include smart watches, smart bands, smart headphones, smart glasses, smart jewelry (smart bracelets, smart bangles, smart rings, smart necklaces, smart anklets, smart ankle chains, and the like), smart wristbands, smart clothing, and the like. The vehicle-mounted device may also be referred to as an on-board terminal, vehicle-mounted controller, vehicle-mounted module, vehicle-mounted component, vehicle-mounted chip, vehicle-mounted unit, or the like. It should be noted that a type of the terminal 11 is not limited in the embodiments of this application. The network-side device 12 may include an access network device or core network device, where the access network device may also be referred to as radio access network (RAN) device, radio access network function, or radio access network unit. The access network device may include base stations, wireless local area network (WLAN) access points (AP), wireless fidelity (WiFi) nodes, or the like. The base station may be referred to as Node B (NB), evolved Node B (eNB), next generation Node B (gNB), new radio Node B (NR Node B), access point, relay base station (RBS), serving base station (SBS), base transceiver station (BTS), radio base station, radio transceiver, basic service set (BSS), extended service set (ESS), home Node B (HNB), home evolved Node B, transmission reception point (TRP) or some other suitable term in the field. As long as the same technical effect is achieved, the base station is not limited to specific technical terms. It should be noted that in the embodiments of this application, the base station in the NR system is taken as an example for description, and a type of the base station is not limited.

The core network device may include but is not limited to at least one of the following: core network node, core network function, mobility management entity (MME), access and mobility management function (AMF), session management function (SMF), user plane function (UPF), policy control function (PCF), policy and charging rules function (PCRF), edge application server discovery function (EASDF), unified data management (UDM), unified data repository (UDR), home subscriber server (HSS), centralized network configuration (CNC), network repository function (NRF), network exposure function (NEF), local NEF (L-NEF), binding support function (BSF), application function (AF), or the like. It should be noted that in the embodiments of this application, the core network device in the NR system is taken as an example for description, and the type of the core network device is not limited.

A mixed reality interaction method provided in embodiments of this application may be applied to various virtual reality scenarios.

In an example, a method for adjusting a QoS policy of a service provided in embodiments of this application may be applied to various virtual reality applications, for example, virtual ball sports and virtual multiplayer games.

In an example, the method for adjusting a QoS policy of a service provided in the embodiments of this application may be applied to viewing scenarios, for example, projecting computer display onto a wall in a virtual space, and may be applied to conference scenarios, for example, a virtual conference room, enabling users to conduct face-to-face meetings with users participating in the meeting as Avatars. This is different from fixed-location virtual online meetings where participating users can only be seen on screens. The virtual conference room, through connectivity of virtual space, makes virtual meetings more realistic.

An execution subject of the method for adjusting a QoS policy of a service provided in the embodiments of this application may be an apparatus for adjusting a QoS policy of a service. The apparatus for adjusting a QoS policy of a service may be applied to a first communication device. A 5G communication system is used as an example, and a first communication device is a policy control function PCF in a communication core network. The communication core network includes at least one of the following network elements: application function AF, network exposure function NEF, network data analytics function NWDAF, network function NF, user plane function UPF, or policy control function PCF.

A method and an apparatus for adjusting a QoS policy of a service, a terminal, and a communication device provided in the embodiments of this application are described in detail below with reference to the accompanying drawings through some embodiments and application scenarios thereof.

Embodiments of this application provide a method for adjusting a QoS policy of a service. FIG. 2 is a flowchart provided in the embodiments of this application. In the method, for example, a first communication device is an execution subject. As shown in FIG. 2, the method for adjusting a QoS policy of a service provided in the embodiments of this application may include the following Step 201 to Step 203.

Step 201: A first communication device receives device status information of a terminal.

In the embodiments of this application, the first communication device is a PCF network element in a core communication network.

In an embodiment of this application, the terminal is a head-mounted electronic device, such as an MR device, VR device, or AR device.

In the embodiments of this application, the device status information is used to characterize a device state of the terminal during execution of a first service.

In the embodiments of this application, the device status information includes at least one of the following: temperature information of the terminal; remaining power information of the terminal; processor load information of the terminal; or other sensor information of the terminal.

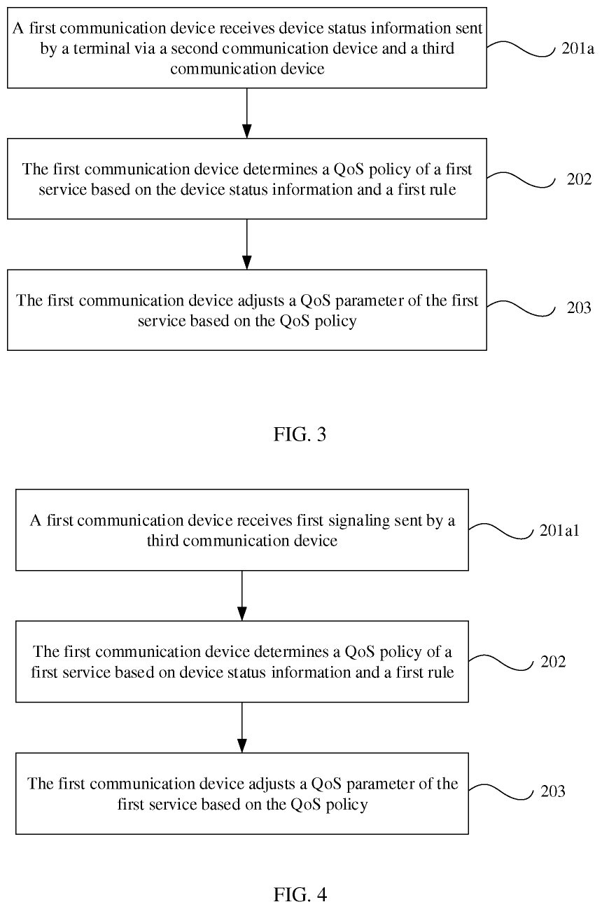

Optionally, in the embodiments of this application, with reference to FIG. 2, as shown in FIG. 3, Step 201 includes Step 201a.

Step 201a: The first communication device receives the device status information sent by the terminal via a second communication device and a third communication device.

In the embodiments of this application, the second communication device may be an AMF network element in the communication core network.

In the embodiments of this application, the third communication device may be an SMF network element in the communication core network.

For example, the device status information is sent by the terminal to the second communication device, then sent by the second communication device to the third communication device, and then sent by the third communication device to the first communication device, so that the first communication device can receive the device status information from the terminal.

Optionally, in the embodiments of this application, with reference to FIG. 3, as shown in FIG. 4, Step 201a includes Step 201a1.

Step 201a1: The first communication device receives first signaling sent by the third communication device.

In the embodiments of this application, the first signaling, the second signaling, and the third signaling are all signaling dedicated to transmission of the device status information.

In the embodiments of this application, the first signaling is sent by the third communication device when receiving the second signaling of the second communication device.

In the embodiments of this application, the second signaling is sent by the second communication device when receiving the third signaling of the terminal.

In the embodiments of this application, the first signaling, second signaling, and third signaling may be RRC signaling.

It should be noted that the first signaling, second signaling, and third signaling may be newly introduced signaling or existing signaling.

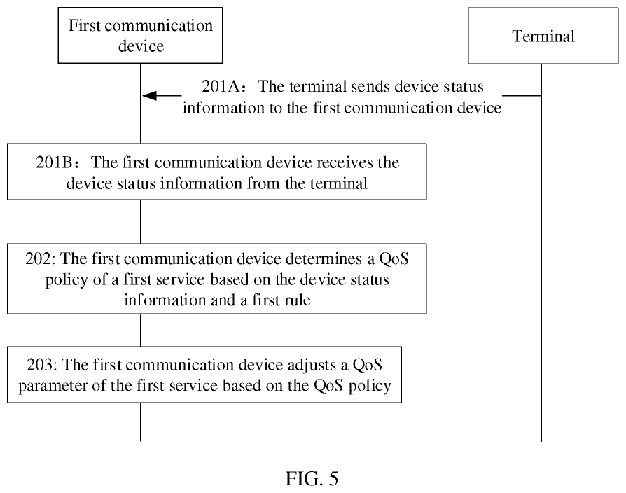

Optionally, in the embodiments of this application, with reference to FIG. 2, as shown in FIG. 5, in the method for adjusting a QoS policy of a service provided in the embodiments of this application, Step 201 further includes the following Step 201A and Step 201B.

Step 201A: The terminal sends the device status information to the first communication device.

For example, the electronic device may acquire the device status information of the terminal in real time, or acquire the device status information of the terminal when the device status information indicates an abnormal state.

For example, the terminal may send the acquired device status information to a base station, and then the base station sends the device status information to the first communication device, or the terminal may directly send the device status information to the first communication device through a NAS message.

Optionally, in the embodiments of this application, the Step 201A includes the following Step 201A1.

Step 201A1: The terminal sends the device status information to the first communication device when a device state of the terminal is abnormal during execution of a first service.

In this way, when the terminal detects that the device state is abnormal, the abnormal information is sent to the first communication device in a timely manner, so that the first communication device may adjust the QoS parameter based on the abnormal state information promptly.

Step 201B: The first communication device receives the device status information from the terminal.

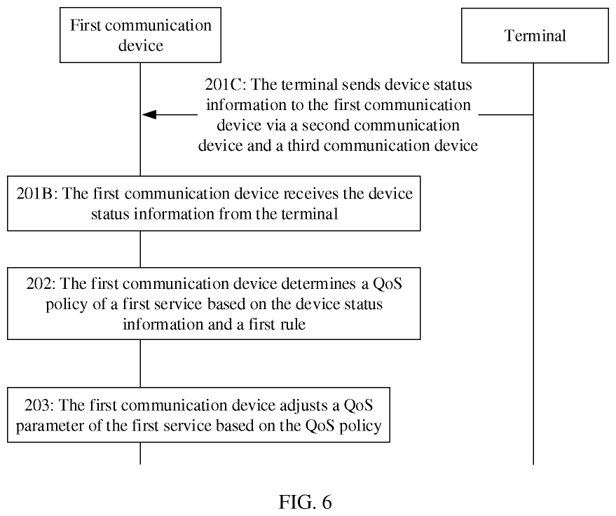

Optionally, in the embodiments of this application, with reference to FIG. 5, as shown in FIG. 6, Step 201A includes Step 201C.

Step 201C: The terminal sends the device status information to the first communication device via the second communication device and the third communication device.

For example, after the terminal sends the device status information to the second communication device, the second communication device sends the device status information to the third communication device, and finally the third communication device sends the device status information to the first communication device, so that a first electronic device may determine a QoS policy of the first service based on the received device status information.

Optionally, in the embodiments of this application, Step 201C includes Step 201C1.

Step 201C1: The terminal sends the third signaling to the second communication device.

In the embodiments of this application, the third signaling is used for the second communication device to send the second signaling to the third communication device.

In the embodiments of this application, the second signaling is used for the third communication device to send the first signaling to the first communication device.

In this way, the device status information can be transmitted between the terminal and the first communication device through a newly introduced signaling message.

Step 202: The first communication device determines the QoS policy of the first service based on the device status information and a first rule.

In the embodiments of this application, the first service is a service currently running on the terminal.

For example, the first service may be a gun battle game service, a sports game service, or the like.

In the embodiments of this application, the QoS policy of the first service includes an uplink QoS policy of the first service and a downlink QoS policy of the first service.

In the embodiments of this application, the QoS policy is used to adjust a transmission parameter of service data of the first service.

In the embodiments of this application, the uplink QoS policy is used to adjust a transmission parameter of uplink service data of the first service.

In the embodiments of this application, the downlink QoS policy is used to adjust a transmission parameter of downlink service data of the first service.

For example, the transmission parameter may include at least one of the following: transmission delay or transmission rate.

In the embodiments of this application, the first rule is that a sum of transmission delays of the uplink service data and the downlink service data satisfies a preset condition.

For example, the preset condition may be expressed as the following formula 1:
transmission delay of uplink service data+transmission delay of downlink service data+T_{processing}+T_{render}<20 ms

For example, the first communication device determines the uplink QoS policy and the downlink QoS policy based on the received device status information, such that the sum of the transmission delay of the uplink service data of the first service adjusted based on the uplink QoS policy, the transmission delay of the downlink service data of the first service adjusted based on the downlink QoS policy, T_{processing}, and T_{render} is less than 20 ms.

Step 203: The first communication device adjusts the QoS parameter of the first service based on the QoS policy.

In the embodiments of this application, the QoS parameter includes the transmission delays of the uplink service data and downlink service data of the first service.

For example, the first communication device determines the QoS parameter corresponding to the QoS policy based on the QoS policy, and then adjusts various transmission parameters in the first service based on the QoS parameter.

In this way, in a case that the terminal is a head-mounted electronic device, when a load of the first service is relatively heavy, the network-side device such as the first communication device may determine the QoS parameter corresponding to the QoS policy based on the QoS policy, and then adjust various transmission parameters in the first service based on the QoS parameter, thereby proactively adjusting the uplink QoS parameter while ensuring that an end-to-end delay remains unchanged, and compensating by lowering the downlink QoS parameter.

It should be noted that lowering the downlink QoS parameters by the network-side device may be implemented by reducing an amount of downlink transmission data, which leads to degradation in an image quality of the head-mounted electronic device. To solve this problem, the head-mounted electronic device may proactively enable image quality compensation by means of frame insertion, adjustment of foveated rendering parameters, and the like.

In the method for adjusting a QoS policy of a service provided in the embodiments of this application, the first communication device receives the device status information of the terminal, where the device status information is used to characterize a device state of the terminal during execution of a first service; the first communication device determines the QoS policy of the first service based on the device status information and the first rule, where the QoS policy of the first service includes an uplink QoS policy of the first service and a downlink QoS policy of the first service, and the QoS policy is used to adjust the transmission parameter of the service data of the first service; the first communication device adjusts the QoS parameter of the first service based on the QoS policy, where the QoS parameter includes the transmission delays of the uplink service data and the downlink service data of the first service; where the first rule is that the sum of the transmission delays of the uplink service data and the downlink service data satisfies a preset condition. In this way, the first communication device may determine the QoS policy of the first service based on the device status information of the terminal, thereby enabling the first communication device to adjust both the transmission delays of the uplink service data and the downlink service data of the first service, to reduce the round-trip delay from the terminal to the first communication device, and thus ensure immersive user experience.

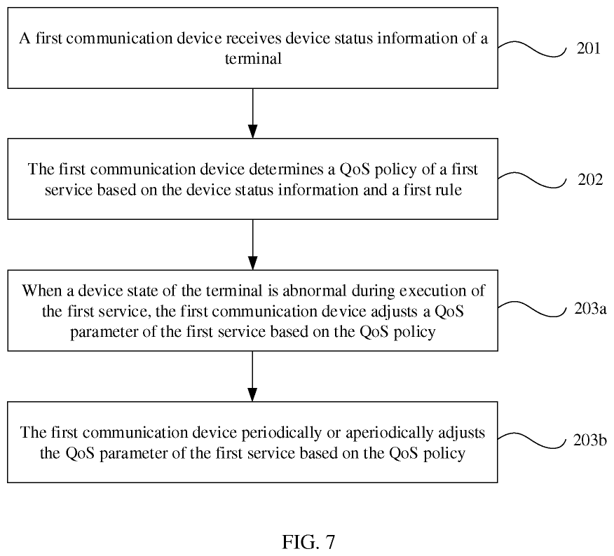

Optionally, in the embodiments of this application, with reference to FIG. 2, as shown in FIG. 7, Step 203 includes Step 203a or Step 203b.

Step 203a: When the device state of the terminal is abnormal during execution of the first service, the first communication device adjusts the QoS parameter of the first service based on the QoS policy.

Optionally, in the embodiments of this application, the abnormal device state includes at least one of the following that:
a temperature of the terminal is greater than or equal to a first threshold;
remaining power of the terminal is less than or equal to a second threshold; or
a processor load of the terminal is greater than or equal to a third threshold.

For example, the first threshold, second threshold, and third threshold may be preset by the electronic device or may be user-defined.

Example 1: The first threshold is 60° C. When the terminal is executing the first service, if the temperature of the terminal reaches 65° C., it is considered that a current device state of the terminal is abnormal, and then the first communication device determines the QoS policy based on the device status information indicating the abnormal state, and adjusts the QoS parameter of the first service based on the QoS parameter corresponding to the QoS policy.

Example 2: The second threshold is 20%. When the terminal is executing the first service, if remaining power of the terminal is 18%, it is considered that a current device state of the terminal is abnormal, and then the first communication device determines the QoS policy based on the device status information indicating the abnormal state, and adjusts the QoS parameter of the first service based on the QoS parameter corresponding to the QoS policy.

Example 3: The third threshold is 80%. When the terminal is executing the first service, if the processor load of the terminal is 80%, it is considered that a current device state of the terminal is abnormal, and then the first communication device determines the QoS policy based on the device status information indicating the abnormal state, and adjusts the QoS parameter of the first service based on the QoS parameter corresponding to the QoS policy.

For example, after detecting that the device state is abnormal during execution of the first service, the terminal sends the device status information indicating the abnormal state to the first communication device, and the first communication device determines the QoS policy based on the device status information indicating the abnormal state, and adjusts the QoS parameter of the first service based on the QoS parameter corresponding to the QoS policy.

Step 203b: The first communication device periodically or aperiodically adjusts the QoS parameter of the first service based on the QoS policy.

For example, “periodically” may mean that every preset period, the first communication device adjusts the QoS parameter of the first service based on the QoS policy.

For example, the preset period may be preset by the first communication device or may be user-defined.

For example, “aperiodically” may mean that when the first communication device detects that the load of the first communication device is relatively heavy, the first communication device proactively adjusts the QoS parameter of the first service based on the QoS policy. In other words, when the first communication device detects that the QoS parameter of the first service need to be adjusted, the first communication device may proactively acquire the device status information, determine the QoS policy, and adjust the QoS parameter of the first service based on the QoS policy.

For example, the terminal continuously sends the device status information to the first communication device in real time, and the first communication device proactively acquires the device status information sent by the terminal periodically or aperiodically, and determines the QoS policy based on the device status information to adjust the QoS parameter of the first service.

In this way, the first communication device may proactively adjust the QoS parameter of the first service rather than reactively make adjustments only after an anomaly occurs, thereby ensuring that a user does not experience obvious delays.

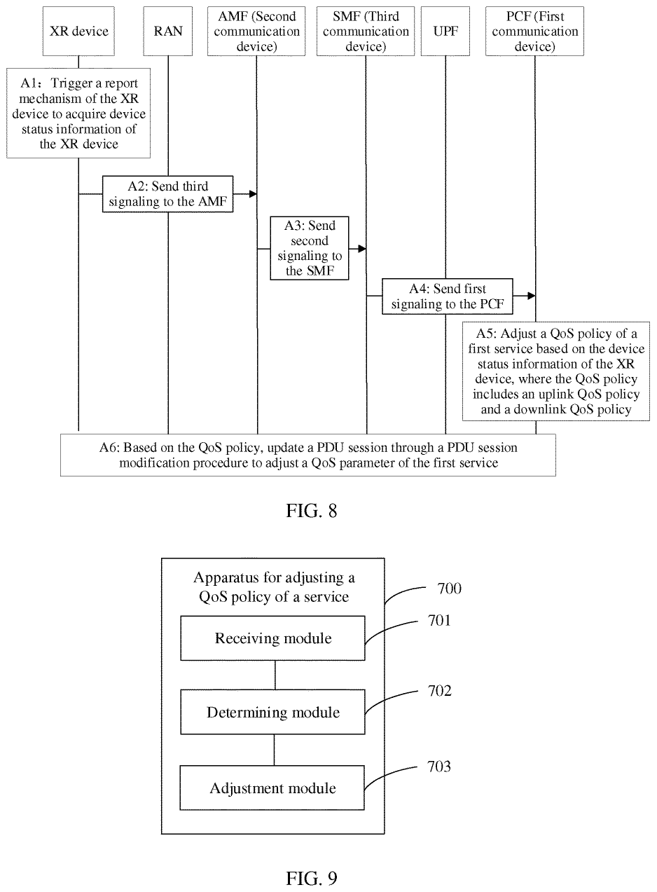

In the following descriptions explaining a detailed process of the method for adjusting a QoS policy of a service provided in the embodiments of this application, for example, the terminal is an XR device, the first communication device is a PCF network element in a core network, the second communication device is an AMF network element in the core network, and the third communication device is an SMF network element in the core network. As shown in FIG. 8, the following steps A0 to A6 are included.

Step A0: It is assumed that the XR device is executing a first service and is in a connected state, and a user plane connection is activated, such as a protocol data unit (PDU) session is established between the XR device and a core network.

Step A1: A report mechanism of the XR device is triggered to acquire device status information of the XR device.

For example, the report mechanism is that the device status data in the XR device reaches a certain preset threshold.

For example, the preset threshold may be sent point-to-point by the network-side device through a new broadcast message field or RRC signaling or RRC message information element IE during registration of the XR device. It can be understood that the network-side device may be a core network or a base station, and network-side devices in the embodiments of this application all represent the core network.

Step A2: The XR device forwards the device status information acquired in step A1 to the AMF network element through third signaling via an N1 interface.

Step A3: The AMF network element forwards the device status information in step A2 to the SMF network element through second signaling via an N11 interface.

Step A4: The SMF network element forwards the device status information in step A3 to the PCF network element through first signaling via an N7 interface.

Step A5: The PCF network element adjusts a QoS policy of a first service based on the device status information of the XR device, where the QoS policy includes an uplink QoS policy and a downlink QoS policy.

Step A6: Based on the QoS policy, the PDU session is updated through a PDU session modification procedure to adjust a QoS parameter of the first service.

In this way, in the embodiments of this application, flexible adjustment of the uplink QoS policy and downlink QoS policy is achieved, ensuring end-to-end delay for sensitive and interactive services, such as application of XR devices in CG services.

In the method for adjusting a QoS policy of a service provided in the embodiments of this application, an execution subject may be an apparatus for adjusting a QoS policy of a service. In the embodiments of this application, an example in which the apparatus for adjusting a QoS policy of a service executes the method for adjusting a QoS policy of a service is used to illustrate the apparatus for adjusting a QoS policy of a service provided in the embodiments of this application.

FIG. 9 is a schematic diagram of a possible structure of an apparatus for adjusting a QoS policy of a service in an embodiment of this application. As shown in FIG. 9, an apparatus 700 for adjusting a QoS policy of a service may include: a receiving module 701, a determining module 702, and an adjustment module 703.

The receiving module 701 is configured to receive device status information of a terminal, where the device status information is used to characterize a device state of the terminal during execution of a first service. The determining module 702 is configured to determine a QoS policy of the first service based on the device status information received by the receiving module 701 and a first rule, where the QoS policy of the first service includes an uplink QoS policy of the first service and a downlink QoS policy of the first service, and the QoS policy is used to adjust a transmission parameter of service data of the first service. The adjustment module 703 is configured to adjust a QoS parameter of the first service based on the QoS policy determined by the determining module 702, where the QoS parameter includes transmission delays of uplink service data and downlink service data of the first service. The first rule is that a sum of the transmission delays of the uplink service data and the downlink service data satisfies a preset condition.

Optionally, in the embodiments of this application, the device status information includes at least one of the following:
temperature information of the terminal;
remaining power information of the terminal;
processor load information of the terminal; or
other sensor information of the terminal.

Optionally, in the embodiments of this application, the receiving module 701 is configured to receive the device status information sent by the terminal via a second communication device and a third communication device.

Optionally, in the embodiments of this application, the receiving module 701 is configured to receive first signaling sent by the third communication device, where the first signaling is sent by the third communication device when receiving second signaling of the second communication device; the second signaling is sent by the second communication device when receiving third signaling of the terminal; and the first signaling, the second signaling, and the third signaling are all signaling dedicated to transmission of the device status information.

Optionally, in the embodiments of this application, the adjustment module 703 is configured to: when a device state of the terminal is abnormal during execution of the first service, adjust the QoS parameter of the first service based on the QoS policy determined by the determining module 702; or periodically or aperiodically adjust the QoS parameter of the first service based on the QoS policy determined by the determining module 702.

Optionally, in the embodiments of this application, the abnormal device state includes at least one of the following that:
a temperature of the terminal is greater than or equal to a first threshold;
remaining power of the terminal is less than or equal to a second threshold; or
a processor load of the terminal is greater than or equal to a third threshold.

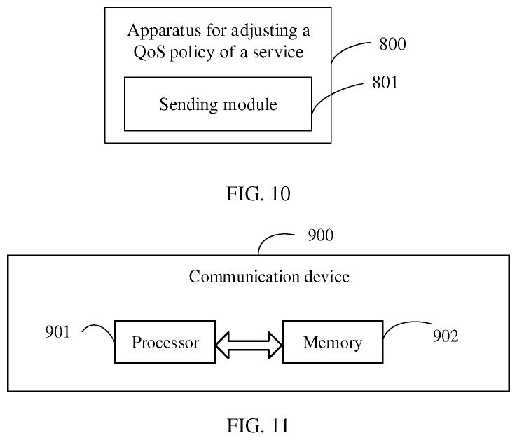

FIG. 10 is a schematic diagram of another possible structure of an apparatus for adjusting a QoS policy of a service in an embodiment of this application. As shown in FIG. 10, an apparatus 800 for adjusting a QoS policy of a service may include: a sending module 801.

The sending module 801 is configured to send device status information to a first communication device, where the device status information is used to characterize a device state of a terminal during execution of a first service; where the device status information is used to determine a QoS policy of the first service; the QoS policy is used to adjust a transmission parameter of service data of the first service; the QoS policy of the first service includes an uplink QoS policy of the first service and a downlink QoS policy of the first service; the QoS policy is used to adjust a QoS parameter of the first service; and the QoS parameter includes transmission delays of uplink service data and downlink service data of the first service.

Optionally, in this embodiment of this application, the device status information includes at least one of the following:
temperature information of the terminal;
remaining power information of the terminal;
processor load information of the terminal; or
other sensor information of the terminal.

Optionally, in this embodiment of this application, the sending module 801 is configured to send the device status information to the first communication device via a second communication device and a third communication device.

Optionally, in this embodiment of this application, the sending module 801 is configured to: send, by the terminal, third signaling to the second communication device; where the third signaling is used for the second communication device to send second signaling to the third communication device; the second signaling is used for the third communication device to send first signaling to the first communication device; and the first signaling, the second signaling, and the third signaling are all signaling dedicated to transmission of the device status information.

Optionally, in this embodiment of this application, the sending module 801 is configured to send, by the terminal, the device status information to the first communication device when the device state of the terminal is abnormal during execution of the first service.

Optionally, in this embodiment of this application, the abnormal device state includes at least one of the following that:
a temperature of the terminal is greater than or equal to a first threshold;
remaining power of the terminal is less than or equal to a second threshold; or
a processor load of the terminal is greater than or equal to a third threshold.

In the apparatus for adjusting a QoS policy of a service provided in this embodiment of this application, device status information of a terminal is received, where the device status information is used to characterize a device state of the terminal during execution of a first service; a QoS policy of the first service is determined based on the device status information and a first rule, where the QoS policy of the first service includes an uplink QoS policy of the first service and a downlink QoS policy of the first service, and the QoS policy is used to adjust a transmission parameter of service data of the first service; a QoS parameter of the first service is adjusted based on the QoS policy, where the QoS parameter includes transmission delays of uplink service data and downlink service data of the first service; where the first rule is that a sum of the transmission delays of the uplink service data and the downlink service data satisfies a preset condition. In this way, the apparatus for adjusting a QoS policy of a service may determine the QoS policy of the first service based on the device status information of the terminal, thereby enabling the apparatus for adjusting a QoS policy of a service to adjust both the transmission delays of the uplink service data and the downlink service data of the first service, to reduce a round-trip delay from the terminal to the apparatus for adjusting a QoS policy of a service, and thus ensure immersive user experience.

The apparatus for adjusting a QoS policy of a service in the embodiments of this application may be an electronic device, such as an electronic device with an operating system, or a component in an electronic device, such as an integrated circuit or chip. The electronic device may be a terminal or other devices other than the terminal. For example, the terminal may include but is not limited to the types of the terminal 11 listed above, and other devices may be a server, a network attached storage (NAS), and the like. This is not limited in the embodiments of this application.

The apparatus for adjusting a QoS policy of a service provided in the embodiments of this application can implement various processes implemented in the method embodiments of FIG. 1 to FIG. 8 and achieve the same technical effects. To avoid repetition, details are not described herein.

As shown in FIG. 11, an embodiment of this application further provides a communication device 900, including a processor 901 and a memory 902. The memory 902 stores a program or an instruction executable on the processor 901. For example, when the communication device 900 is a terminal, various steps in the embodiments of the method for adjusting a QoS policy of a service described above are implemented when the program or instruction is executed by the processor 901, and the same technical effects can be achieved. When the communication device 900 is a network-side device, various steps in the embodiments of the method for adjusting a QoS policy of a service described above are implemented when the program or instruction is executed by the processor 901, and the same technical effects can be achieved. To avoid repetition, details are not described herein.

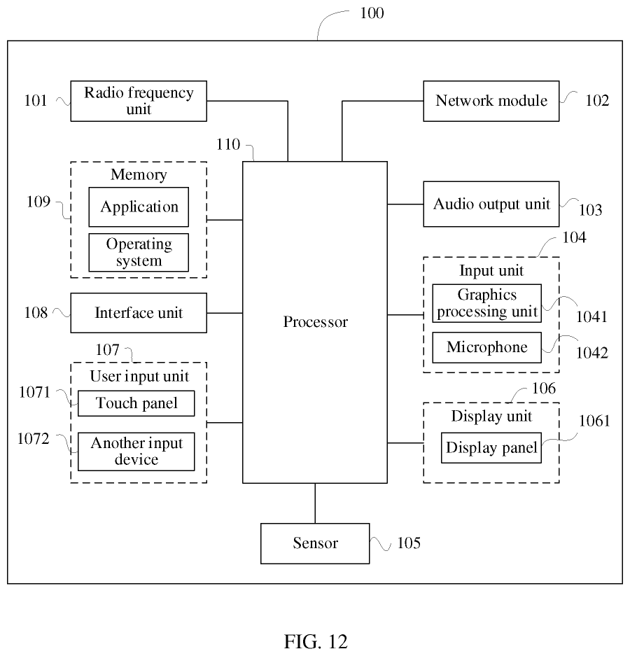

An embodiment of this application further provides a terminal, including a processor and a communication interface. The communication interface is coupled to the processor, and the processor is configured to run a program or an instruction to implement the steps in the method embodiment shown in FIG. 2. This terminal embodiment corresponds to the above terminal-side method embodiment, and various implementation processes and implementation manners in the above method embodiment can be applied to this terminal embodiment, and the same technical effects can be achieved. Optionally, FIG. 12 is a schematic diagram of a hardware structure of a terminal implementing the embodiments of this application.

The terminal 100 includes but is not limited to at least some components of a radio frequency unit 101, a network module 102, an audio output unit 103, an input unit 104, a sensor 105, a display unit 106, a user input unit 107, an interface unit 108, a memory 109, a processor 110, and the like.

Those skilled in the art can understand that the terminal 100 may further include a power supply (such as a battery) for supplying power to various components. The power supply may be logically connected to the processor 110 through a power management system, thereby implementing functions such as charge, discharge, and power consumption management through the power management system. The terminal structure shown in FIG. 12 does not constitute a limitation to the terminal. The terminal may include more or fewer components than illustrated, or some components may be combined, or different component arrangements may be used. Details are not described herein.

It should be understood that, in this embodiment of this application, the input unit 104 may include a graphics processing unit (GPU) 1041 and a microphone 1042. The graphics processing unit 1041 processes image data of still pictures or videos obtained by an image capture device (such as a camera) in a video capture mode or an image capture mode. The display unit 106 may include a display panel 1061, and the display panel 1061 may be a liquid crystal display, an organic light-emitting diode, or the like. The user input unit 107 includes at least one of a touch panel 1071 or another input device 1072. The touch panel 1071 is also referred to as a touch screen. The touch panel 1071 may include two parts: a touch detection device and a touch controller. The another input device 1072 may include but is not limited to a physical keyboard, function key (such as a volume control key or switch key), trackball, mouse, joystick, and the like. Details are not described herein.

In this embodiment of this application, after receiving downlink data from a network-side device, the radio frequency unit 101 may transmit the data to the processor 110 for processing; in addition, the radio frequency unit 101 may send uplink data to the network-side device. Generally, the radio frequency unit 101 includes but is not limited to an antenna, an amplifier, a transceiver, a coupler, a low-noise amplifier, a duplexer, and the like.

The memory 109 may be configured to store a software program or an instruction as well as various data. The memory 109 may mainly include a first storage area storing programs or instructions and a second storage area storing data, where the first storage area may store an operating system, an application or instruction required for at least one function (such as a sound play function or an image play function), and the like. In addition, the memory 109 may include volatile memory or non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 109 in this embodiment of this application includes but is not limited to these memories and any other suitable types of memories.

The processor 110 may include one or more processing units. Optionally, the processor 110 integrates an application processor and a modem processor, where the application processor mainly processes operations related to operating systems, user interfaces, and applications, and the modem processor mainly processes wireless communication signals, for example, may be a baseband processor. It can be understood that the modem processor may not be integrated into the processor 110.

The radio frequency unit 101 is configured to send device status information to a first communication device, where the device status information is used to characterize a device state of a terminal during execution of a first service; where the device status information is used to determine a QoS policy of the first service; the QoS policy is used to adjust a transmission parameter of service data of the first service; the QoS policy of the first service includes an uplink QoS policy of the first service and a downlink QoS policy of the first service; the QoS policy is used to adjust a QoS parameter of the first service; and the QoS parameter includes transmission delays of uplink service data and downlink service data of the first service.

Optionally, in this embodiment of this application, the device status information includes at least one of the following:
temperature information of the terminal;
remaining power information of the terminal;
processor load information of the terminal; or
other sensor information of the terminal.

Optionally, in this embodiment of this application, the radio frequency unit 101 is configured to send the device status information to the first communication device via a second communication device and a third communication device.

Optionally, in this embodiment of this application, the radio frequency unit 101 is configured to: send, by the terminal, third signaling to the second communication device; where the third signaling is used for the second communication device to send second signaling to the third communication device; the second signaling is used for the third communication device to send first signaling to the first communication device; and the first signaling, the second signaling, and the third signaling are all signaling dedicated to transmission of the device status information.

Optionally, in this embodiment of this application, the radio frequency unit 101 is configured to send, by the terminal, the device status information to the first communication device when the device state of the terminal is abnormal during execution of the first service.

Optionally, in this embodiment of this application, the abnormal device state includes at least one of the following that:
a temperature of the terminal is greater than or equal to a first threshold;
remaining power of the terminal is less than or equal to a second threshold; or
a processor load of the terminal is greater than or equal to a third threshold.

In this way, the first communication device may determine the QoS policy of the first service based on the device status information of the terminal, thereby enabling the first communication device to adjust both the transmission delays of the uplink service data and the downlink service data of the first service, to reduce the round-trip delay from the terminal to the first communication device, and thus ensure immersive user experience.

It can be understood that for the implementation processes of the various implementations mentioned in the embodiments, reference may be made to the relevant descriptions in the method embodiments and the same or corresponding technical effects can be achieved. To avoid repetition, details are not described herein.

An embodiment of this application further provides a network-side device, including a processor and a communication interface. The communication interface is coupled to the processor, and the processor is configured to run a program or an instruction to implement the steps in the method embodiment shown in FIG. 2. This network-side device embodiment corresponds to the above network-side device method embodiment, and various implementation processes and implementation manners of the above method embodiment can be applied to this network-side device embodiment, and the same technical effects can be achieved.

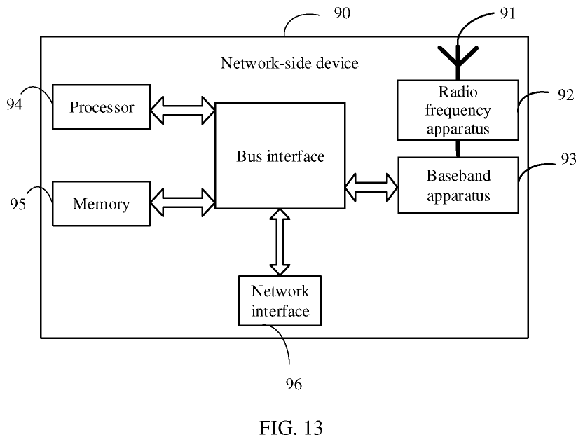

Optionally, an embodiment of this application further provides a network-side device. As shown in FIG. 13, the network-side device 90 includes: an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information through the antenna 91 and sends the received information to the baseband apparatus 93 for processing. In a downlink direction, the baseband apparatus 93 processes information to be sent and sends the information to the radio frequency apparatus 92. The radio frequency apparatus 92 processes received information and then sends the information through the antenna 91.

The method executed by the network-side device in the above embodiments may be implemented by the baseband apparatus 93, and the baseband apparatus 93 includes a baseband processor.

For example, the baseband apparatus 93 may include at least one baseband board, where the baseband board is provided with multiple chips. As shown in FIG. 13, one chip is, for example, a baseband processor, and is connected to the memory 95 through a bus interface to invoke a program in the memory 95 and execute the network device operations shown in the above method embodiments.

The network-side device may further include a network interface 96, where the interface is, for example, a common public radio interface (CPRI).

Optionally, the network-side device 90 of embodiments of the present application further includes: an instruction or a program stored on the memory 95 and executable on the processor 94. The processor 94 invokes the instruction or program in the memory 95 to execute the methods executed by various modules shown in FIG. 8, and the same technical effects can be achieved. To avoid repetition, details are not described herein.

An embodiment of this application further provides a non-transitory readable storage medium, where the non-transitory readable storage medium stores a program or an instruction. When the program or instruction is executed by a processor, various processes in the embodiments of the method for adjusting a QoS policy of a service described above are implemented, and the same technical effects can be achieved. To avoid repetition, details are not described herein.

The processor is the processor in the terminal described in the above embodiments. The non-transitory readable storage medium includes a non-transitory computer-readable storage medium, such as a computer read-only memory ROM, random access memory RAM, magnetic disk, or optical disk.

An embodiment of this application further provides a chip, where the chip includes a processor and a communication interface. The communication interface is coupled to the processor. The processor is configured to run a program or an instruction to implement various processes in the embodiments of the method for adjusting a QoS policy of a service described above, and the same technical effects can be achieved. To avoid repetition, details are not described herein.

It should be understood that the chip in this embodiment of this application may also be referred to as a system on chip, system on a chip, system-on-chip, SoC, or the like.

An embodiment of this application further provides a computer program/program product, where the computer program/program product is stored in a non-transitory storage medium, and the computer program/program product is executed by at least one processor to implement various processes in the embodiments of the method for adjusting a QoS policy of a service described above, and the same technical effects can be achieved. To avoid repetition, details are not described herein.

It should be noted that, in this application, the terms “include”, “contain” or any other variants thereof are intended to cover non-exclusive inclusion, so that a process, method, object or apparatus including a series of elements not only includes those elements, but also includes other elements not explicitly listed, or elements inherent to such process, method, object or apparatus. Without further limitation, an element defined by the statement “include a . . . ” does not exclude the presence of additional identical elements in the process, method, object or apparatus including the element. In addition, it should be noted that the scope of the methods and apparatuses in the implementations of this application is not limited to the shown or discussed order in which the functions are performed, and may also include a substantially simultaneous or reverse performing order of the functions. For example, the described methods may be performed in an order different from the described order, and various steps may be added, omitted, or combined. In addition, features described with reference to certain examples may be combined in other examples.

Through the description of the above implementations, those skilled in the art can clearly understand that the methods in the above embodiments can be implemented by computer software product on a necessary general hardware platform, and certainly may alternatively be implemented by hardware. The computer software product is stored in a non-transitory storage medium (such as ROM, RAM, magnetic disk, or optical disk), and includes several instructions for enabling a terminal or network-side device to execute the methods described in various embodiments of this application.

The embodiments of this application are described above with reference to the accompanying drawings, but this application is not limited to the embodiments described above. The above embodiments are only illustrative, not restrictive. Those of ordinary skill in the art may devise various forms of implementations under the inspiration of this application without departing from the purpose of this application and the protection scope of the claims. All these implementations fall within the protection of this application.

What is claimed is:

1. A method for adjusting a quality of service (QoS) policy of a service, comprising:
receiving, by a first communication device, device status information of a terminal, wherein the device status information is used to characterize a device state of the terminal during execution of a first service;
determining, by the first communication device, a QoS policy of the first service based on the device status information and a first rule, wherein the QoS policy of the first service comprises an uplink QoS policy of the first service and a downlink QoS policy of the first service, and the QoS policy is used to adjust a transmission parameter of service data of the first service; and
adjusting, by the first communication device, a QoS parameter of the first service based on the QoS policy, wherein the QoS parameter comprises transmission delays of uplink service data and downlink service data of the first service; wherein
the first rule is that a sum of the transmission delays of the uplink service data and the downlink service data satisfies a preset condition.

2. The method according to claim 1, wherein the device status information comprises at least one of the following:
temperature information of the terminal;
remaining power information of the terminal;
processor load information of the terminal; or
other sensor information of the terminal.

3. The method according to claim 1, wherein the receiving, by a first communication device, device status information of a terminal comprises:
receiving, by the first communication device, the device status information sent by the terminal via a second communication device and a third communication device.

4. The method according to claim 3, wherein the receiving, by the first communication device, the device status information sent by the terminal via a second communication device and a third communication device comprises:
receiving, by the first communication device, first signaling sent by the third communication device; wherein
the first signaling is sent by the third communication device when receiving second signaling of the second communication device; the second signaling is sent by the second communication device when receiving third signaling of the terminal; and the first signaling, the second signaling, and the third signaling are all signaling dedicated to transmission of the device status information.

5. The method according to claim 1, wherein the adjusting, by the first communication device, a QoS parameter of the first service based on the QoS policy comprises:
when a device state of the terminal is abnormal during execution of the first service, adjusting, by the first communication device, the QoS parameter of the first service based on the QoS policy;
or
periodically or aperiodically adjusting, by the first communication device, the QoS parameter of the first service based on the QoS policy.

6. The method according to claim 5, wherein the abnormal device state comprises at least one of the following that:
a temperature of the terminal is greater than or equal to a first threshold;
remaining power of the terminal is less than or equal to a second threshold; or
a processor load of the terminal is greater than or equal to a third threshold.

7. A method for adjusting a quality of service (QoS) policy of a service, comprising:
sending, by a terminal, device status information to a first communication device, wherein the device status information is used to characterize a device state of the terminal during execution of a first service; wherein
the device status information is used to determine a QoS policy of the first service; the QoS policy is used to adjust a transmission parameter of service data of the first service; the QoS policy of the first service comprises an uplink QoS policy of the first service and a downlink QoS policy of the first service; the QoS policy is used to adjust a QoS parameter of the first service; and the QoS parameter comprises transmission delays of uplink service data and downlink service data of the first service.

8. The method according to claim 7, wherein the device status information comprises at least one of the following:
temperature information of the terminal;
remaining power information of the terminal;
processor load information of the terminal; or
other sensor information of the terminal.

9. The method according to claim 7, wherein the sending, by a terminal, device status information to a first communication device comprises:
sending, by the terminal, the device status information to the first communication device via a second communication device and a third communication device.

10. The method according to claim 9, wherein the sending, by the terminal, the device status information to the first communication device via a second communication device and a third communication device comprises:
sending, by the terminal, third signaling to the second communication device; wherein
the third signaling is used for the second communication device to send second signaling to the third communication device; the second signaling is used for the third communication device to send first signaling to the first communication device; and the first signaling, the second signaling, and the third signaling are all signaling dedicated to transmission of the device status information.

11. The method according to claim 9, wherein the sending, by a terminal, device status information to a first communication device comprises:
sending, by the terminal, the device status information to the first communication device when a device state of the terminal is abnormal during execution of the first service.

12. The method according to claim 11, wherein the abnormal device state comprises at least one of the following that:
a temperature of the terminal is greater than or equal to a first threshold;
remaining power of the terminal is less than or equal to a second threshold; or
a processor load of the terminal is greater than or equal to a third threshold.

13. A first communication device, comprising a processor and a memory, wherein the memory stores a program or an instruction executable on the processor; and the program or instruction, when executed by the processor, causes the first communication device to perform:
receiving device status information of a terminal, wherein the device status information is used to characterize a device state of the terminal during execution of a first service;
determining a quality of service (QoS) policy of the first service based on the device status information and a first rule, wherein the QoS policy of the first service comprises an uplink QoS policy of the first service and a downlink QoS policy of the first service, and the QoS policy is used to adjust a transmission parameter of service data of the first service; and
adjusting a QoS parameter of the first service based on the QoS policy, wherein the QoS parameter comprises transmission delays of uplink service data and downlink service data of the first service; wherein
the first rule is that a sum of the transmission delays of the uplink service data and the downlink service data satisfies a preset condition.

14. The first communication device according to claim 13, wherein the device status information comprises at least one of the following:
temperature information of the terminal;
remaining power information of the terminal;
processor load information of the terminal; or
other sensor information of the terminal.

15. The first communication device according to claim 13, wherein the program or instruction, when executed by the processor, causes the first communication device to perform:
receiving the device status information sent by the terminal via a second communication device and a third communication device.

16. The first communication device according to claim 15, wherein the program or instruction, when executed by the processor, causes the first communication device to perform:
receiving first signaling sent by the third communication device; wherein
the first signaling is sent by the third communication device when receiving second signaling of the second communication device; the second signaling is sent by the second communication device when receiving third signaling of the terminal; and the first signaling, the second signaling, and the third signaling are all signaling dedicated to transmission of the device status information.

17. The first communication device according to claim 13, wherein the program or instruction, when executed by the processor, causes the first communication device to perform:
when a device state of the terminal is abnormal during execution of the first service, adjusting the QoS parameter of the first service based on the QoS policy;
or
periodically or aperiodically adjusting the QoS parameter of the first service based on the QoS policy;
wherein the abnormal device state comprises at least one of the following that:
a temperature of the terminal is greater than or equal to a first threshold;
remaining power of the terminal is less than or equal to a second threshold; or
a processor load of the terminal is greater than or equal to a third threshold.

18. A terminal, comprising a processor and a memory, wherein the memory stores a program or an instruction executable on the processor; and when the program or instruction is executed by the processor, the steps of the method for adjusting a QoS policy of a service according to claim 7 are implemented.

19. A non-transitory readable storage medium, wherein the non-transitory readable storage medium stores a program or an instruction; when the program or the instruction is executed by a processor, the steps of the method for adjusting a QoS policy of a service according to claim 1 are implemented.

20. A non-transitory readable storage medium, wherein the non-transitory readable storage medium stores a program or an instruction; when the program or the instruction is executed by a processor, the steps of the method for adjusting a QoS policy of a service according to claim 7 are implemented.
